(19) United States
(12) Patent Application Publication
(10) Pub. No.: US 2024/0317545 A1
(43) Pub. Date: Sep. 26, 2024

(54) JIG FOR SUSPENDING HEAVY OBJECT

(71) Applicant: TAIKOH Co., Ltd., Toyota-shi (JP)

(72) Inventors: Yasuharu Asai, Toyota-shi (JP); Takahumi Asai, Toyota-shi (JP)

(21) Appl. No.: 18/607,905

(22) Filed: Mar. 18, 2024

(30) Foreign Application Priority Data
Mar. 23, 2023 (JP) 2023-047162

(51) Int. Cl. B66C 13/00

(52) U.S. Cl. CPC B66C 13/00

(57) ABSTRACT

A jig for suspending a heavy object is provided that when transporting a heavy object in a suspended manner, firmly holds the heavy object and thus allows the heavy object to be smoothly and safely transported in a suspended manner. The jig for suspending a heavy object includes a body block, a slide block having a lock on the top surface thereof and fitted into a hollow formed in the body block so as to pass through the body block in the up-down direction, and a drive shaft that has, on one end thereof, an inner-diameter clamp mechanism including a head and is inserted into the body block from a side surface of the body block so as to penetrate the slide block. A concave portion having a parabolic sectional shape is formed on one side surface of the slide block.

### CROSS-REFERENCE TO RELATED APPLICATIONS

This application claims priority to Japanese Application No. 2023-047162, having a filing date of Mar. 23, 2023, the entire contents of which are hereby incorporated by reference.

### FIELD OF TECHNOLOGY

The following relates to a jig for suspending a heavy object and, more specifically, a jig for suspending a heavy object that is used when transporting a heavy object in a suspended manner in an automobile assembly plant or the like.

### BACKGROUND

For example, when mounting a transmission, which is a heavy object, to an engine in an automobile assembly plant, the transmission is hoisted using a chain block and transported to the position wherein the transmission is to be mounted to the engine, in a suspended manner using an overhead crane, post-type jib crane, or the like. In this case, a hook on the lower end of the chain block of the transportation crane is hooked on lock means or a lock for locking the transmission.

The lock means or a lock is a rod-shaped member to be inserted into a positioning hole formed on the transmission or a newly formed hook hole, or a hook to be hooked on a newly provided protrusion. However, any of the rod-shaped members and hook may come off the transmission and involves a risk since these members are not firmly fixed to the transmission. Moreover, newly forming a portion having no relationship with the performance of the transmission results in useless cost.

### SUMMARY

As described above, the conventional heavy object lock means or a lock used to transport a heavy object such as a transmission in a suspended manner may come off the heavy object and involve a risk since these means are not firmly fixed to the heavy object to be suspended. An aspect relates to a jig for suspending a heavy object that when transporting a heavy object in a suspended manner, is able to firmly hold the heavy object so that the heavy object is smoothly and safely transported in a suspended manner.

To solve the above problem, embodiments of the present invention provide a jig for suspending a heavy object including a drive shaft having on an end thereof, an inner-diameter clamp mechanism to be inserted into a lateral or longitudinal hole of a heavy object to be suspended. When a hanging weight of the heavy object is applied to the drive shaft in an axial direction of the drive shaft or a direction perpendicular to the shaft, the inner-diameter clamp mechanism operates in the hole and the jig is firmly fixed to the heavy object.

To solve the above problem, embodiments of the present invention also provide a jig for suspending a heavy object including a body block, a slide block having lock means or a lock on a top surface thereof and fitted into a hollow formed in the body block so as to pass through the body block in an up-down direction, and a drive shaft having an inner-diameter clamp mechanism on a front end thereof and inserted into the body block from a side surface of the body block so as to penetrate the slide block. A concave portion having a parabolic sectional shape is formed on a side surface of the slide block. A through hole into which the drive shaft is movably inserted is formed in a central portion of the concave portion. An action member having a curved slide contact surface corresponding to the concave portion is disposed in the concave portion. The drive shaft is inserted through the action member. When the inner-diameter clamp mechanism is inserted into a hole of a heavy object to be suspended and then the lock means or a lock is lifted, a diameter of the inner-diameter clamp mechanism is increased in the hole.

In one embodiment, the action member has a cylindrical or spherical shape, or a semicylindrical sectional shape having a curved side surface.

In one embodiment, the inner-diameter clamp mechanism includes a first tapered surface formed on a head on the front end of the drive shaft, a second tapered surface formed on a shaft cylinder that is fitted to an outer side surface of the body block and into which the drive shaft is slidably inserted, multiple movable pieces that have inclined end surfaces slidingly in contact with the first tapered surface and the second tapered surface and are disposed between the first tapered surface and the second tapered surface, and a ring holding the movable pieces.

In one embodiment, means configured to prevent come-off of the drive shaft is disposed on a rear end of the drive shaft. In one embodiment, means configured to prevent rotation of the drive shaft is disposed on the body block.

To solve the above problem, embodiments of the present invention also provide a jig for suspending a heavy object including a body block and a drive shaft having lock means or a lock on a upper end thereof and an inner-diameter clamp mechanism on a lower end thereof and slidably inserted through the body block. When the inner-diameter clamp mechanism is inserted into a hole of a heavy object to be suspended and then the lock means or a lock is lifted, a diameter of the inner-diameter clamp mechanism is increased in the hole.

In one embodiment, the inner-diameter clamp mechanism includes a first tapered surface formed on a head on a front end of the drive shaft, a second tapered surface formed on a shaft cylinder that is fitted to a bottom surface of the body block and into which the drive shaft is slidably inserted, multiple movable pieces that have inclined end surfaces slidingly in contact with the first tapered surface and the second tapered surface and are disposed between the first tapered surface and the second tapered surface, and a ring holding the movable pieces.

The jigs for suspending a heavy object according to embodiments of the present invention are configured as described above. When transporting a heavy object in a suspended manner, the jigs are firmly fixed to the heavy object without requiring any operation or effort since the inner-diameter clamp mechanism operates by simply lifting the heavy object. This allows the heavy object to be firmly and safely held and suspended and thus to be smoothly and safely transported in a suspended manner.

### BRIEF DESCRIPTION

Some of the embodiments will be described in detail, with reference to the following figures, wherein like designations denote like members, wherein:

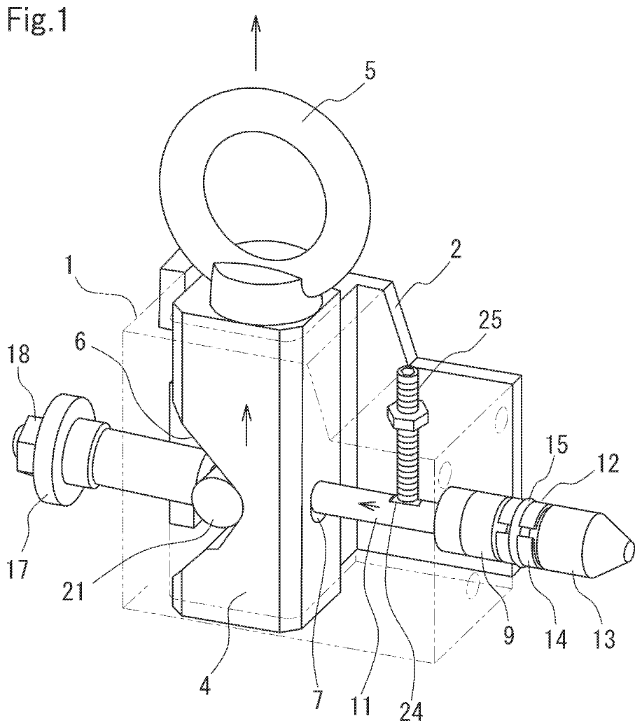

FIG. 1 depicts a perspective view except for a body block of a jig for suspending a heavy object according to a first embodiment of the present invention;

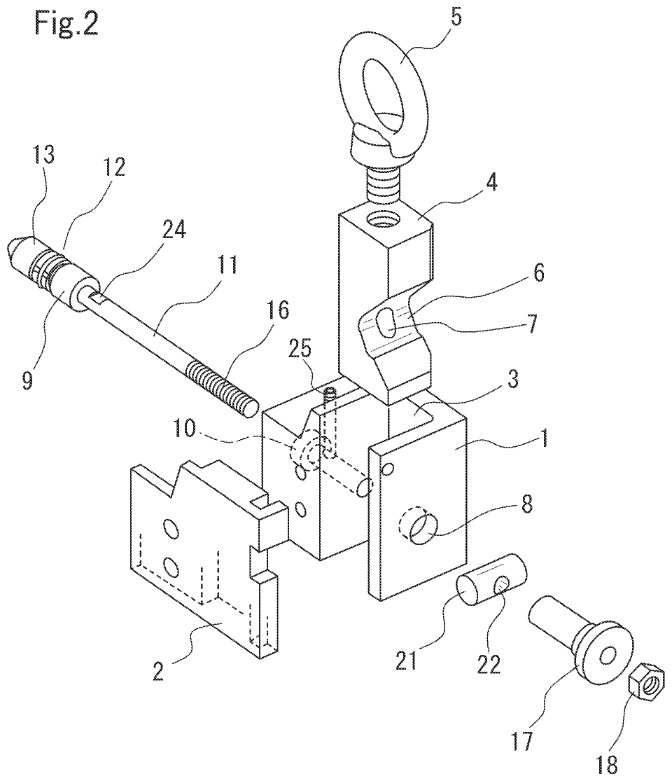

FIG. 2 depicts an exploded perspective view of the jig for suspending a heavy object according to the first embodiment of the present invention;

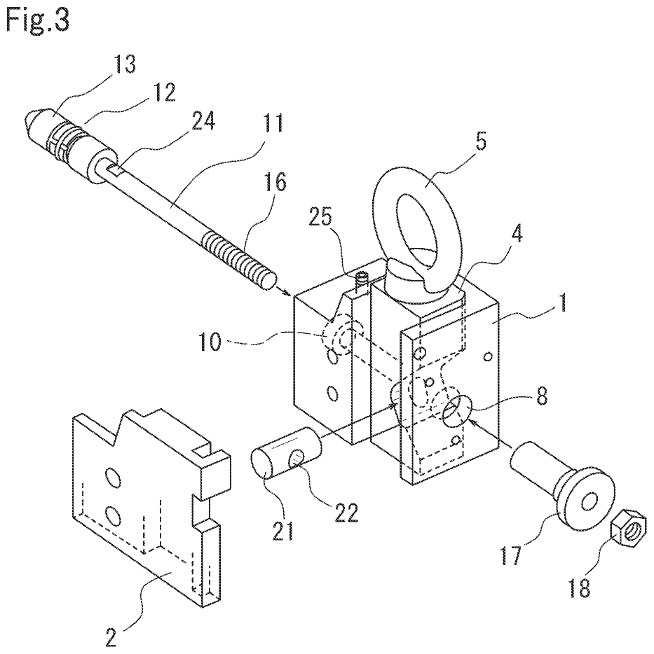

FIG. 3 depicts an exploded perspective view showing a method for assembling the jig for suspending a heavy object according to the first embodiment of the present invention;

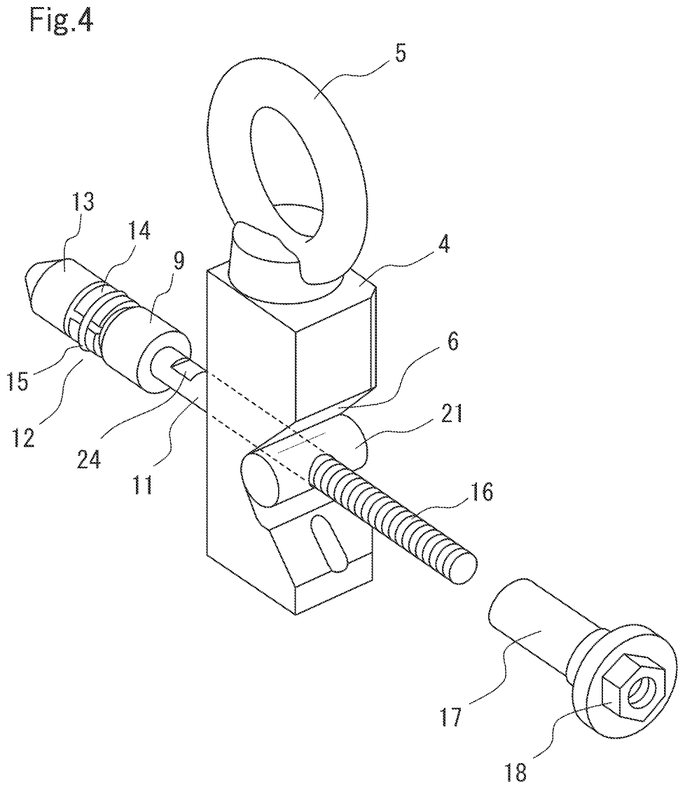

FIG. 4 depicts a perspective view showing an example shape and incorporated state of an action member of the jig for suspending a heavy object according to embodiments of the present invention;

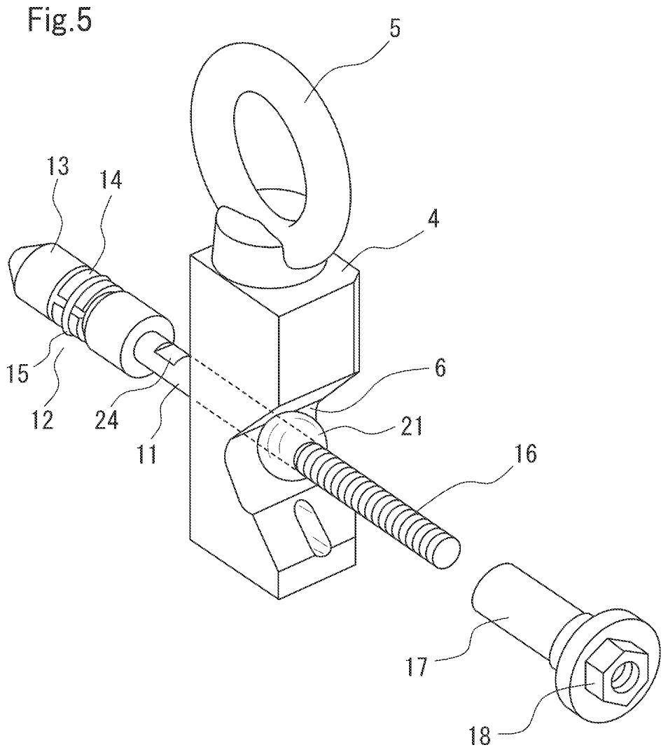

FIG. 5 depicts a perspective view showing another example shape and incorporated state of an action member of the jig for suspending a heavy object according to embodiments of the present invention;

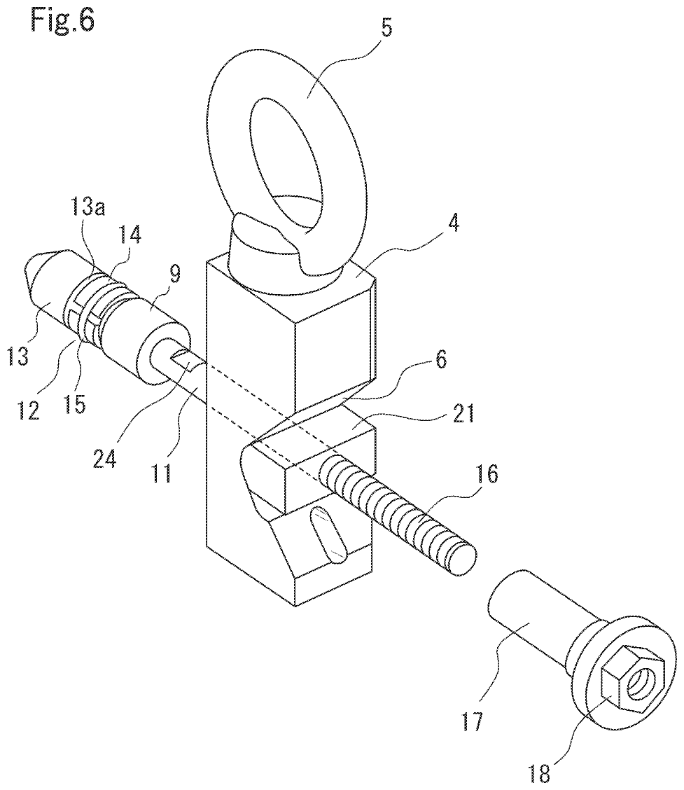

FIG. 6 depicts a perspective view showing yet another example shape and incorporated state of an action member of the jig for suspending a heavy object according to embodiments of the present invention;

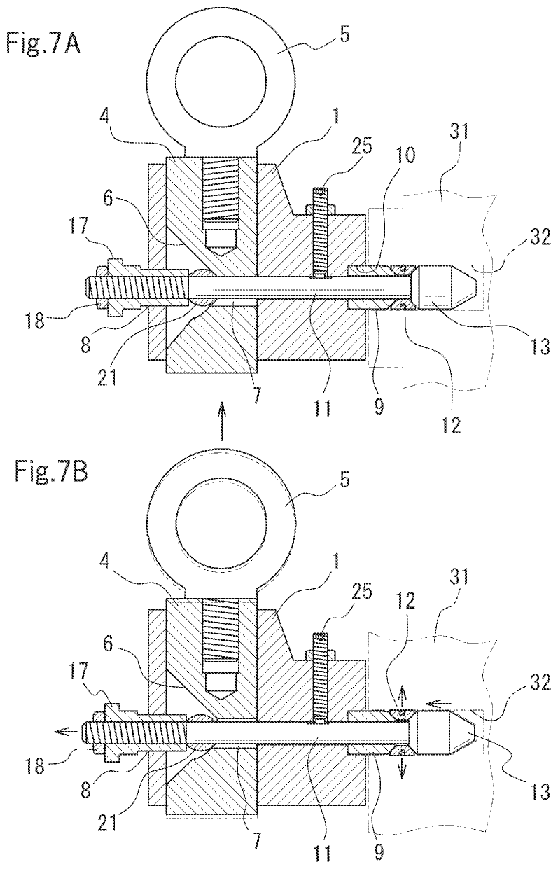

FIG. 7A depicts a longitudinal sectional view showing the action of the jig for suspending a heavy object according to the first embodiment of the present invention;

FIG. 7B depicts a longitudinal sectional view showing the action of the jig for suspending a heavy object according to the first embodiment of the present invention;

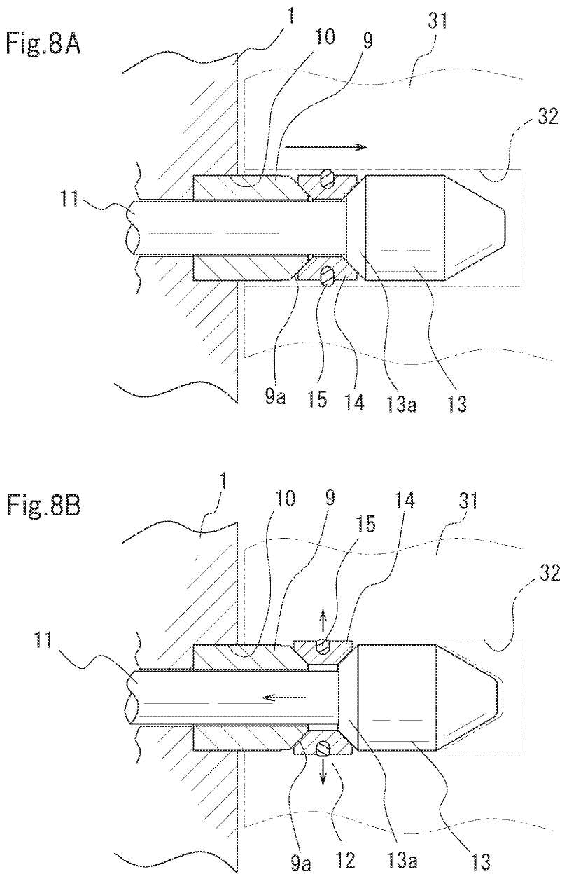

FIG. 8A depicts a major portion expanded sectional view showing the action of the jig for suspending a heavy object according to the first embodiment of the present invention;

FIG. 8B depicts a major portion expanded sectional view showing the action of the jig for suspending a heavy object according to the first embodiment of the present invention;

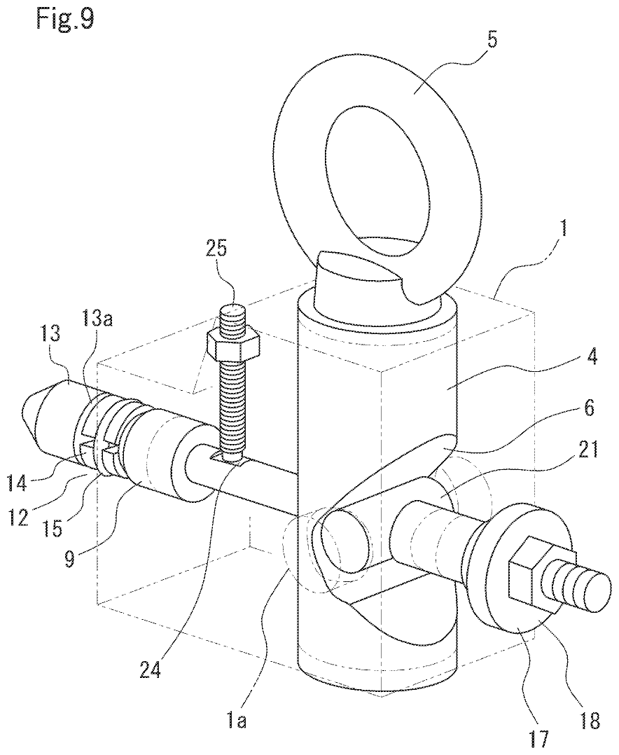

FIG. 9 depicts a perspective view except for a body block of a jig for suspending a heavy object according to a second embodiment of the present invention;

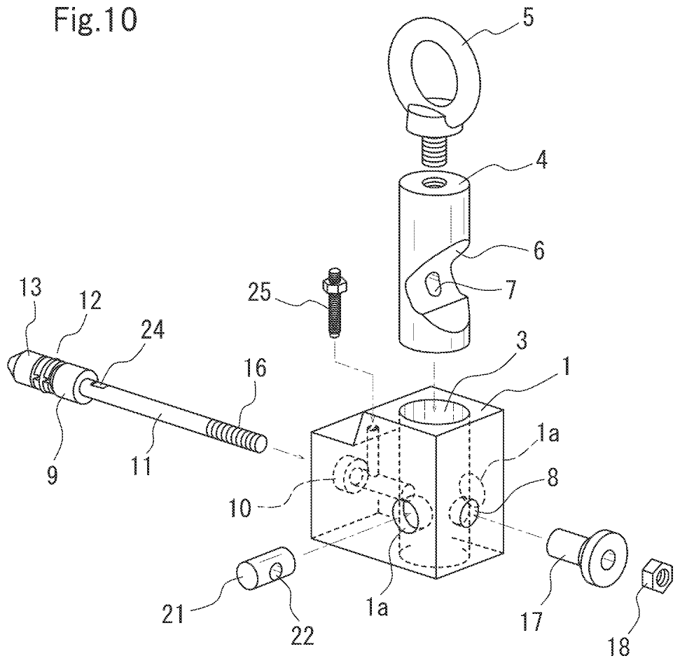

FIG. 10 depicts an exploded perspective view of the jig for suspending a heavy object according to the second embodiment of the present invention;

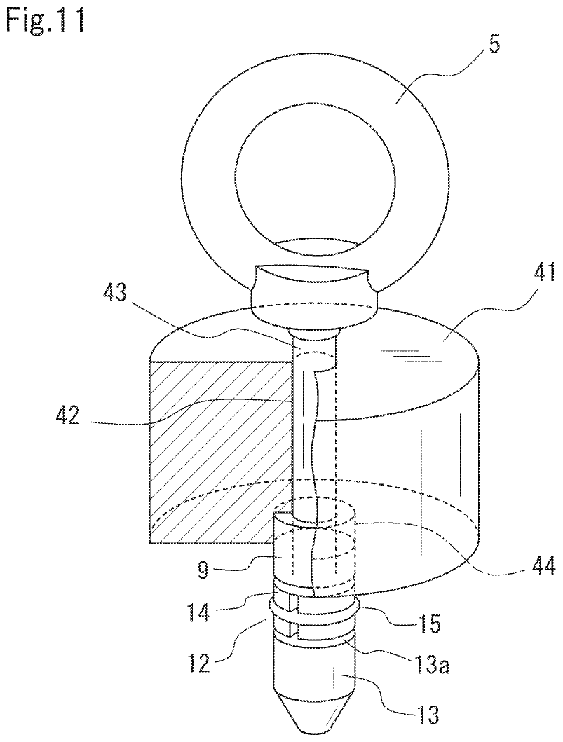

FIG. 11 depicts a partially cutaway perspective view of a jig for suspending a heavy object according to a third embodiment of the present invention;

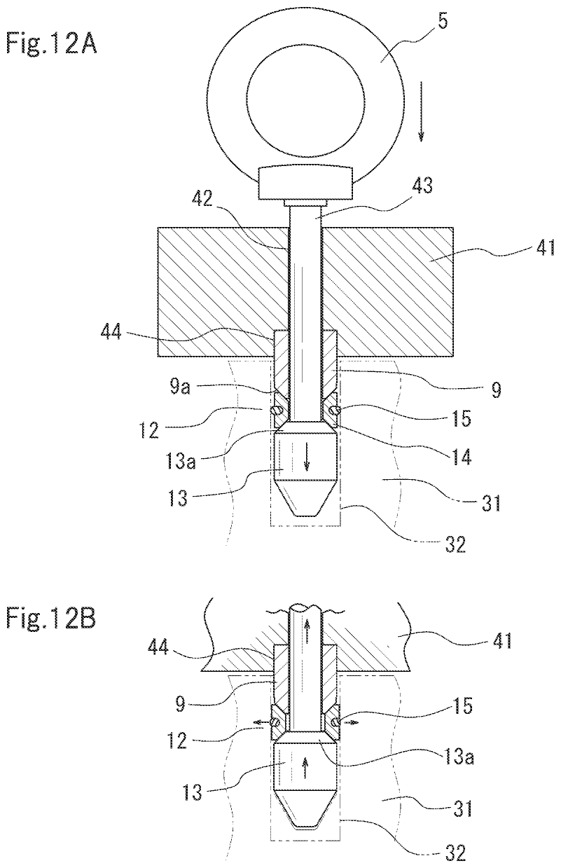

FIG. 12A depicts a longitudinal sectional view showing the action of the jig for suspending a heavy object according to the third embodiment of the present invention;

FIG. 12B depicts a longitudinal sectional view showing the action of the jig for suspending a heavy object according to the third embodiment of the present invention; and

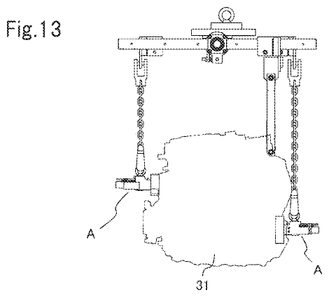

FIG. 13 depicts a drawing showing a state wherein the jigs for suspending a heavy object according to embodiments of the present invention are being used.

### DETAILED DESCRIPTION

A jig for suspending a heavy object according to embodiments of the present invention includes a drive shaft having on an end thereof, an inner-diameter clamp mechanism to be inserted into a lateral or longitudinal hole of a heavy object to be suspended. By applying a hanging weight associated with the lift of the heavy object to the drive shaft in the axial direction of the drive shaft or a direction perpendicular to the shaft, the inner-diameter clamp mechanism operates in the hole and the jig is firmly fixed to the heavy object. For example, it is assumed that a transmission is mounted to an engine in an automobile assembly plant by hoisting the transmission and transporting it in a suspended manner to the position wherein the transmission is to be mounted to the engine. In this case, one or more jigs according to embodiments of the present invention are mounted on the transmission so that the transmission can be firmly and safely transported (see FIG. 13). Note that the object to be transported is any heavy object and is not limited to a transmission, as a matter of course.

FIG. 1 is a perspective view (except for a body block) of a jig for suspending a heavy object according to a first embodiment of the present invention, and FIG. 2 is an exploded perspective view of the entire jig. As shown, the jig for suspending a heavy object according to embodiments of the present invention includes, for example, a body block 1 that includes a detachable lid plate 2 as one side surface thereof and has a hollow 3 that passes therethrough in the up-down direction, a slide block 4 having lock means or a lock (for example, a hanging ring 5) on the top surface thereof and slidably fitted into the hollow 3 of the body block 1, and a drive shaft 11 having an inner-diameter clamp mechanism 12 on an end thereof and inserted into the body block 1 from a side surface of the body block 1 so as to penetrate the slide block 4. The hanging ring 5 is fixed, for example, by screwing a male thread disposed on the hanging ring 5 in a protruding manner into a female thread disposed on the top surface of the slide block 4.

A concave portion 6 having a parabolic shape in a side view is formed on one side surface of the slide block 4, and a through hole 7 into which the drive shaft 11 is movably inserted is formed in the deep central portion of the concave portion 6 (see FIG. 7). The through hole 7 is formed in a slightly longitudinally long shape so that the drive shaft 11 can slightly move in the up-down direction. While the slide block 4 shown is a quadrangular prism, it may be a cylinder (FIG. 9) as shown in a second embodiment (to be discussed later) or may be a polygonal prism such as a hexagonal prism.

A guide hole 8 into which a stopper 17 disposed on the rear end of the drive shaft 11 is slidably fitted is formed on a side surface of the body block 1 so as to be opposed to the through hole 7. A fitting hole 10 into which a shaft cylinder 9 constituting a part of the inner-diameter clamp mechanism 12 (to be discussed later) is fitted is formed on the opposite side surface of the body block 1 in a recessed manner (particularly, see FIG. 8).

The inner-diameter clamp mechanism 12 is disposed on the front end of the drive shaft 11. The inner-diameter clamp mechanism 12 includes a tapered surface (first tapered surface) 13a formed on a head 13 having a large diameter on the front end of the drive shaft 11, a tapered surface (second tapered surface) 9a formed on the shaft cylinder 9 opposed to the head 13, and multiple movable pieces 14 that are incorporated between the tapered surfaces 9a and 13a and whose inclined end surfaces are slidingly in contact with the tapered surfaces 9a and 13a (see FIG. 8). The movable pieces 14 are held by an O ring 15 or C ring so as to be slightly movable in the radial direction.

A male thread 16 is formed on the rear end of the drive shaft 11, and the stopper 17 is fitted to the male thread 16 and fixed by a nut 18. The drive shaft 11 is inserted into the fitting hole 10, starting with its rear end, and passed through an action member 21 disposed on the concave portion 6 of the slide block 4, and the male thread 16 is exposed from the guide hole 8 of the body block 1. By fitting the shaft cylinder 9 into the fitting hole 10, fitting the stopper 17 to the exposed male thread 16, and screwing and tightening the nut 18 on the male thread 16, the inner end surface of the stopper 17 contacts the action member 21 in the concave portion 6 in a pressed manner (see FIG. 7).

The action member 21 shown in FIGS. 1 to 4 has a cylindrical shape and has, in its central portion, a through hole 22 into which the drive shaft 11 is inserted. Its curved surface is slidingly in contact with the inclined surface of the concave portion 6. The action member 21 is only required to have a curved surface that can slidingly contact the inclined surface of the concave portion 6. The action member 21 may have a shape other than a cylindrical shape, such as a spherical shape as shown in FIG. 5 or may have a semicylindrical sectional shape having a curved side surface as shown in FIG. 6.

In an embodiment, means configured to prevent rotation of the drive shaft 11 is disposed on the body block 1. One example of the rotation prevention means is a screw rod 25 having a flat front end and configured to be screwed into a flat portion 24 formed on the circumferential surface of the drive shaft 11 through the top surface or a side surface of the body block 1.

A method for assembling the jig for suspending a heavy object according to embodiments of the present invention will be described with reference to FIG. 3. First, the lid plate 2 is removed, and the action member 21 is inserted into the concave portion 6. Then, the rear end of the drive shaft 11 is inserted into the fitting hole 10 and passed through the through hole 22 of the action member 21, and the male thread 16 is exposed from the guide hole 8 of the body block 1. At the same time, the shaft cylinder 9 is pressed into the fitting hole 10. Thus, the shaft cylinder 9 is fixed to the side surface of the body block 1 and no longer moves. Note that the drive shaft 11 can slidingly move with respect to the shaft cylinder 9.

Then, the stopper 17 is fitted to the male thread 16 of the drive shaft 11 exposed from the guide hole 8 and tightened using the nut 18 until the inner end surface of the stopper 17 contacts the action member 21 (see FIG. 7). If the means configured to prevent rotation of the drive shaft 11 (screw rod 25) is disposed, the screw rod 25 is screwed through the top surface or a side surface of the body block 1 until it contacts the flat portion 24 of the drive shaft 11. The jig for suspending a heavy object according to embodiments of the present invention is used, for example, when mounting a transmission to an engine in an automobile assembly plant by hoisting the transmission and transporting the transmission to the mounting position in a suspended manner. To mount the jig on a heavy object 31 such as a transmission, the inner-diameter clamp mechanism 12 on the front end of the drive shaft 11 is inserted into a fitting hole 32 of the heavy object 31 (see FIGS. 7 and 8). While the fitting hole 32 may be newly formed, an existing positioning hole or the like is typically used as the fitting hole 32. When hoisting the heavy object 31, four or so positions of the heavy object 31 are locked. For example, it is assumed that jigs A for suspending a heavy object according to embodiments of the present invention are used in two of the four or so positions (see FIG. 13).

When the front end of the drive shaft 11 of each jig A configured as described above is inserted into the fitting hole 32 of the heavy object 31 and then the heavy object 31 is lifted using a crane or the like, the slide block 4 is lifted through the hanging ring 5. As described above, the slide block 4 is housed in the hollow 3 of the body block 1 so as to be slidable in the up-down direction, and the drive shaft 11 is movably inserted in the longitudinally long through hole 7 of the slide block 4. For this reason, the slide block 4 can rise in the hollow 3 until the drive shaft 11 contacts the bottom surface of the through hole 7 (see FIG. 7B).

As the slide block 4 rises, the action member 21 whose curved surface is in contact with the inclined surface of the concave portion 6 receives an upward pressing force from the inclined surface. However, the action member 21 is not able to move upward due to the drive shaft 11 passing therethrough and attempts to escape in the lateral direction along the drive shaft 11. As a result, as the inclined surface of the concave portion 6 rises, the action member 21 acts such that the drive shaft 11 moves in the left direction of FIGS. 7A and 7B through the stopper 17 and nut 18. At this time, the shaft cylinder 9 is pressed in the fitting hole 10 and does not move. For this reason, the drive shaft 11 slightly moves in the axial direction integrally with the action member 21, stopper 17, and nut 18 while leaving the shaft cylinder 9.

When the drive shaft 11 moves in the axial direction as described above, the movable pieces 14 are pushed by the tapered surface 13a of the head 13 and sandwiched between the tapered surface 13a and the tapered surface 9a of the shaft cylinder 9 in a pressed manner. As a result, the movable pieces 14 swell in the radial direction and thus the O ring 15 (or C ring) strongly presses the inner circumferential surface of the fitting hole 32. This prevents the drive shaft 11 from coming off the fitting hole 32. The heavy object 31 in this state is transported in a suspended manner and then put down on a workbench, floor, or the like. Thus, the lifting force is released, and the slide block 4 descends in the hollow 3 by self-weight. Thus, the inclined surface of the concave portion 6 no longer presses the action member 21. As a result, the drive shaft 11 returns to its original position, and the inner-diameter clamp mechanism 12 no longer acts on the inner circumferential surface of the fitting hole 32. This allows the drive shaft 11 to be removed from the fitting hole 32.

FIGS. 9 and 10 show a jig for suspending a heavy object according to a second embodiment of the present invention, and the second embodiment differs from the first embodiment in the shape of the body block 1 and slide block 4. Specifically, a slide block 4 according to the second embodiment has a cylindrical shape, and a hollow 3 formed in a body block 1 also has a cylindrical shape corresponding to the slide block 4.

Moreover, while the body block 1 according to the first embodiment includes the detachable lid plate 2 as one side surface and the action member 21 is inserted by removing the lid plate 2, the body block 1 according to the second embodiment is a block consisting of a single component without a lid plate 2. An opening(s) la into and from which the action member 21 is to be inserted and removed is formed on one side surface or both side surfaces of the body block 1. Note that, as with the body block 1 according to the second embodiment, the body block 1 according to the first embodiment may also, of course, have a configuration without the lid plate 2. Other components having the same reference signs as those in the first embodiment are the same as those in the first embodiment.

The usage and action/effect of the second embodiment do not differ from those of the first embodiment.

Next, a jig for suspending a heavy object according to a third embodiment shown in FIG. 11 will be described. The jig according to the third embodiment does not include the slide block 4 according to the first or second embodiment. It includes a body block 41 and a drive shaft 43 having lock means or a lock (hanging ring 5) on the upper end thereof and an inner-diameter clamp mechanism 12 on the lower end thereof and slidably inserted into a slide hole 42 of the body block 41. The configuration of the inner-diameter clamp mechanism 12 does not differ from that of the inner-diameter clamp mechanisms 12 according to the first and second embodiments. Other components having the same reference signs as those in the first and second embodiments are the same as those in the first and second embodiments.

The body block 41 according to the third embodiment is a block having a cylindrical or any other shape. The slide hole 42 is disposed so as to pass through the body block 41 in the up-down direction from the top surface to the bottom surface, and the drive shaft 43 is slidably inserted into the slide hole 42. The lower end of the slide hole 42 has an increased diameter and is provided with a fitting hole 44, and a shaft cylinder 9 of the drive shaft 43 is fitted into the fitting hole 44. The drive shaft 43 is inserted into the slide hole 42 of the body block 41 from the bottom side, and the shaft cylinder 9 is fitted into the fitting hole 44. A male thread 16 of the drive shaft 43 is exposed from the top surface of the body block 41, and a female thread of the hanging ring 5 serving as lock means or a lock is screwed on the exposed male thread 16.

The jig for suspending a heavy object according to the third embodiment is used by inserting the inner-diameter clamp mechanism 12 into a fitting hole 32 disposed on the top surface of a heavy object 31 from above. When the inner-diameter clamp mechanism 12 is inserted into the fitting hole 32 and then the hanging ring 5 is hoisted, the drive shaft 43 rises while leaving the heavy body block 41, due to its being slidable with respect to the body block 41 and the shaft cylinder 9 fixed to the body block 41. Thus, movable pieces 14 are pushed up by the tapered surface 13a of a head 13 and sandwiched between the tapered surface 13a and the tapered surface 9a of the shaft cylinder 9 in a pressed manner. As a result, the movable pieces 14 are pushed out in the radial direction and thus an O ring 15 (or C ring) strongly presses the inner circumferential surface of the fitting hole 32. This prevents the drive shaft 42 from coming off the fitting hole 32.

When the hanging ring 5 is further lifted in this state, the heavy object 31 is also lifted along with the hanging ring 5 and is allowed to be transported. As in the above embodiments, when the heavy object 31 is transported in a suspended manner in this state and then put down on a work bench, floor, or the like, the lifting force is released and the drive shaft 43 descends by self-weight. As a result, the tapered surface 13a of the head 13 and the tapered surface 9a of the shaft cylinder 9 lose the force to sandwich the movable pieces 14 in a pressed manner, and the inner-diameter clamp mechanism 12 no longer acts on the inner circumferential surface of the fitting hole 32. This allows the drive shaft 43 to be removed from the fitting hole 32.

The jigs for suspending a heavy object according to embodiments of the present invention can be repeatedly used, as a matter of course.

The jigs for suspending a heavy object according to embodiments of the present invention are configured as described above. When transporting a heavy object in a suspended manner, any of these jigs can be firmly fixed to the heavy object without requiring any operation or effort since the inner-diameter clamp mechanism operates by simply lifting the heavy object. This allows the heavy object to be firmly and safely held and suspended and thus to be smoothly and safely transported in a suspended manner. For this reason, the jigs for suspending a heavy object according to embodiments of the present invention have high industrial applicability.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

What is claimed is:

1. A jig for suspending a heavy object, comprising a drive shaft having, on an end thereof, an inner-diameter clamp mechanism to be inserted into a lateral or longitudinal hole of the heavy object to be suspended, wherein
when a hanging weight of the heavy object is applied to the drive shaft in an axial direction of the drive shaft or a direction perpendicular to the shaft, the inner-diameter clamp mechanism operates in the hole and the jig is firmly fixed to the heavy object.

2. A jig for suspending a heavy object, comprising:
a body block;
a slide block having a lock on a top surface thereof and fitted into a hollow formed in the body block so as to pass through the body block in an up-down direction; and
a drive shaft having an inner-diameter clamp mechanism on a front end thereof and inserted into the body block from a side surface of the body block so as to penetrate the slide block,
wherein a concave portion having a parabolic sectional shape is formed on a side surface of the slide block, wherein a through hole into which the drive shaft is movably inserted is formed in a central portion of the concave portion,
wherein an action member having a curved slide contact surface corresponding to the concave portion is disposed in the concave portion,
wherein the drive shaft is inserted through the action member,
wherein when the inner-diameter clamp mechanism is inserted into a hole of the heavy object to be suspended and then the lock is lifted, a diameter of the inner-diameter clamp mechanism is increased in the hole of the heavy object.

3. The jig for suspending the heavy object of claim 2, wherein the slide block has a prism shape or cylindrical shape.

4. The jig for suspending the heavy object of claim 2, wherein the action member has a cylindrical or spherical shape, or a semicylindrical sectional shape having a curved side surface.

5. The jig for suspending the heavy object of claim 2, wherein
the inner-diameter clamp mechanism comprises:
a first tapered surface formed on a head on the front end of the drive shaft;
a second tapered surface formed on a shaft cylinder that is fitted to an outer side surface of the body block and into which the drive shaft is slidably inserted;
a plurality of movable pieces that have inclined end surfaces slidingly in contact with the first tapered surface and the second tapered surface and are disposed between the first tapered surface and the second tapered surface; and
a ring holding the movable pieces.

6. The jig for suspending the heavy object of claim 2, wherein come-off prevention means is disposed on a rear end of the drive shaft.

7. The jig for suspending the heavy object of claim 2, wherein means configured to prevent rotation of the drive shaft is disposed on the body block.

8. The jig for suspending a heavy object, comprising:
a body block; and
a drive shaft having a lock on an upper end thereof and an inner-diameter clamp mechanism on a lower end thereof and slidably inserted through the body block, wherein
when the inner-diameter clamp mechanism is inserted into a hole formed on the heavy object to be suspended and then the lock is lifted, a diameter of the inner-diameter clamp mechanism is increased in the hole.

9. The jig for suspending the heavy object of claim 8, wherein
the inner-diameter clamp mechanism comprises:
a first tapered surface formed on a head on a front end of the drive shaft;
a second tapered surface formed on a shaft cylinder that is fitted to a bottom surface of the body block and into which the drive shaft is slidably inserted;
a plurality of movable pieces that have inclined end surfaces slidingly in contact with the first tapered surface and the second tapered surface and are disposed between the first tapered surface and the second tapered surface; and
a ring holding the movable pieces.
